(19) United States
(12) Patent Application Publication
(10) Pub. No.: US 2003/0115248 A1
(43) Pub. Date: Jun. 19, 2003

(54) Method and system for supporting eating habits

(75) Inventors: Mitsuo Kitada, Tokyo (JP); Eriko Tanaka, Tokyo (JP)

Correspondence Address: Finnegan, Henderson, Farabow,, Garrett & Dunner, L.L.P., 1300 I Street, N.W., Washington, DC, 20005-3315, US

(73) Assignee: AJINOMOTO CO., Inc.

(21) Appl. No.: 10/319,673

(22) Filed: Dec. 16, 2002

(30) Foreign Application Priority Data
Dec. 17, 2001 (JP) 2001-383715

(51) Int. Cl. G06F 15/16; G06F 17/00

(52) U.S. Cl. 709/200; 707/104.1

(57) ABSTRACT

A menu is made out while managing nutrition for a plurality of members for a predetermined period and selecting familiar foodstuffs and often served dishes. A method for supporting eating habits includes: determining a dietary requirement and an ingredient intake target with reference to a table on the basis of the attributes of each member; obtaining eating habit information on foodstuffs to store the information in a storage section; subtracting the nutritional intake of a restricted diet contained in the attributes from the dietary requirement, to determine a nutritional intake to be managed; determining, from the ingredient intake target, a difference between the nutritional intake to be calculated and the nutritional intake to be managed; and minimizing the difference on the basis of the eating habit information on foodstuffs to determine a required ingredient intake.

This application claims priority from Japanese Patent Application No. 2001-383715 filed Dec. 17, 2001, which is incorporated hereinto by reference.

### BACKGROUND OF THE INVENTION

1. Field of the Invention

The present invention relates to a method and system for supporting eating habits, and more specifically, to a method and system for supporting eating habits which supports a cooker in making out a menu when he or she serves dishes to one or more members sitting around a dining table.

2. Description of the Related Art

Various menus should be provided, for example, on a daily basis considering nutritional balance. However, cooking can be classified in terms of various points such as dishes used or food additives such as seasoning, spices, and coloring agents (hereinafter collectively referred to as “foodstuffs”), or nutritive values or cookeries. Various dishes can be combined together to provide an infinite number of menus. Much labor is required to decide desired dishes from foodstuffs used. Furthermore, experiences and capabilities of cookers are important factors in making out menus by combining dishes together considering the nutritive values.

Systems have hitherto been known which allows foodstuffs used to be selected to obtain menus, nutritive values, and cookeries for dishes using these foodstuffs. These systems have been improved in various ways in order to improve convenience. For example, Japanese Patent Application Laid-Open No. 8-161288 (1996) describes an electronic menu making-out apparatus that can make out menus with better-balanced nutrition considering the nutritive values of past menus.

Further, Japanese Patent Application Laid-Open No. 11-318352 (1999) describes a menu making-out system that can select a standard menu and alter its components to make out various menus. Furthermore, Japanese Patent Application Laid-Open No. 5-128126 (1993) describes a menu plan making-out system that makes out a menu plan on the basis of a basic menu pattern to assign dishes on the menu plan.

The types of foodstuffs are limited which general families can buy at retail stores. Further, the types of foodstuffs are limited because of a whole week's supply of foodstuffs concerning purchase units and purchase prices. On the other hand, the types of dishes and selection of foodstuffs tend to be biased depending on the tastes of cooker. Accordingly, even if menus with balanced nutritive values or various menus are planned, enough foodstuffs may not be obtained, and disadvantageously, no dishes may actually be served.

Further, nutritional management is important to general families. However, it is difficult to strictly manage nutrition for each member of the family, because the respective family members have different tastes and nutritional intakes and because some families often eat out or are under dietary restrictions because of a certain disease. For example, Japanese Patent Application Laid-Open No. 2001-243326 describes creation of a menu based on the stored tastes and nutritional intakes of the family members. However, it is difficult to achieve strict nutritional management involving not only management of calorie intakes but also essential nutrients simply by making out a menu on the basis of previously stored dishes. Furthermore, as described above, it is disadvantageously difficult to make out a menu using only familiar foodstuffs or often served dishes.

### SUMMARY OF THE INVENTION

It is an object of the present invention to provide a method and system for supporting eating habits which can manage nutrition for a plurality of members over a predetermined period by using familiar foodstuffs and often served dishes.

To attain this object, a method for supporting eating habits in which, when a menu for a predetermined period is made out for one or more members sitting around a table, a control section makes out the menu with reference to a storage section on the basis of eating habit information obtained from an input section, the storage section having a table that stores dietary requirements for one day and ingredient intake targets for respective foodstuffs classified into food groups, the dietary requirements and ingredient intake targets being based on attributes of the members, as well as food nutritive components of each foodstuff or dish, the method comprising: a first calculating step of determining, for each of the members, a dietary requirement for the predetermined period and an ingredient intake target for the predetermined period, with reference to the table on the basis of the attributes of each member stored in the storage section; a first inputting step of obtaining eating habit information on foodstuffs often used from the input section to store the information in the storage section; a second calculating step of subtracting the nutritional intake of a restricted diet contained in the attributes from the dietary requirement for the predetermined period which has been determined at the first calculating step, to determine a nutritional intake to be managed; a third calculating step of determining, from the ingredient intake target for the predetermined period which has been determined at the first calculating step, a difference between the nutritional intake calculated with reference to the table and the nutritional intake to be managed which has been determined at the second calculating step; and a fourth calculating step of minimizing the difference determined at the third calculating step on the basis of the eating habit information on foodstuffs often used which has been obtained at the first inputting step, to determine a required ingredient intake for the predetermined period.

The first inputting step may comprise obtaining eating habit information on dine-out for each of the members from the input section to store the information in the storage section, and the third calculating step may comprise subtracting, from the dietary requirement for the predetermined period, a nutritional intake calculated from the eating habit information on dine-out obtained at the first inputting step.

Also, the method further may comprise a second inputting step of obtaining selected dishes to store the dishes in the storage sections in order to make out a menu for the predetermined period; and a display step of displaying, for the dishes selected at the second inputting step, the amounts of foodstuffs calculated with reference to the table and required ingredient intakes for the predetermined period which have been determined at the fourth calculating step.

Furthermore, the storage section has a recipe table in which a manner of preparing each dish is stored, and the method may comprise a procedure making-out step of, for the plurality of dishes selected at the second inputting step, detecting and classifying verbs relating to cooking for each dish with reference to the recipe table and making out a cooking procedure by rearranging the detected verbs.

Furthermore, the method further may comprise a diagnosis step of storing, in the storage section, the nutritional intake calculated from the eating habit information on dine-out and the nutritional intake to be managed and displaying nutritional intakes for the predetermined period in order to diagnose eating habits.

According to the present invention, familiar foodstuffs and often served dishes can be registered beforehand. Further, foodstuffs can be added or changed even when a menu is made out by selecting dishes. Consequently, a menu can be efficiently made out using familiar foodstuffs.

Further, according to the present invention, nutrition for all family members can be managed on a weekly basis considering how often the family eats out and the like.

### BRIEF DESCRIPTION OF THE DRAWINGS

The above and other objects, effects, features and advantages of the present invention will become more apparent from the following description of embodiments thereof taken in conjunction with the accompanying drawings.

FIG. 1 is a view showing a configuration of a support system of eating habits according to an embodiment of the present invention;

FIG. 2 is a block diagram of the hardware configuration of a server in the support system of eating habits according to this embodiment of the present invention;

FIG. 3 is a flow chart showing a method for supporting eating habits according to a first embodiment of the present invention;

FIG. 4 is a view showing a screen in which foodstuffs often used for the family are registered;

FIG. 5 is a view showing a screen in which dishes often prepared for the family are registered;

FIG. 6 is a view showing a screen in which recipes for dishes often prepared for the family are registered;

FIG. 7 is a view showing a screen in which eating habits information for a week is registered;

FIG. 8 is a view showing a configuration of a database in the support system of eating habits according to the embodiment of the preset invention shown in FIG. 1;

FIG. 9 is a flow chart showing a method for calculating required foodstuffs according to the method for supporting eating habits;

FIG. 10 is a flow chart showing a method for making out a menu in the method for supporting eating habits;

FIG. 11 is a view showing a screen in which a menu is made out according to the method for supporting eating habits;

FIGS. 12A to 12C are views showing the results of output of a menu made out according to the method for supporting eating habits;

FIG. 13 is a view showing a login screen;

FIG. 14 is a view showing an attribute input screen;

FIG. 15 is a view showing results of calculation of nutrition required for a week;

FIG. 16 is a view showing a screen that displays the required amounts of vegetables;

FIG. 17 is a view showing a screen in which desired vegetables are input;

FIG. 18 is a view showing a menu calendar screen used to make out a menu;

FIG. 19 is a screen used to select theme vegetables;

FIG. 20 is a screen used to decide a menu;

FIG. 21 is a view showing a screen displayed when all desired dishes have been selected;

FIG. 22 is a view showing a screen used to change the amounts of ingredients of a dish;

FIG. 23 is a flow chart showing how to prepare a food;

FIG. 24 is a view showing a screen that shows how to prepare a food; and

FIG. 25 is a view showing a screen displaying the results of eating habit diagnosis.

### DETAILED DESCRIPTION OF PREFERRED EMBODIMENTS

Embodiments of the present invention will be described below in detail with reference to the drawings. In the present embodiment, description will be given of the case in which a housewife of a general family who is engaged in cooking makes out a menu considering nutritional balance for the family members. It should be appreciated that the present embodiment is applicable to the case in which a cook serves dishes to one or more members sitting around a dining table for a predetermined period, e.g. it is necessary to make out a menu for a school or dormitory lunch program or for hospital dishes.

Further, in the present embodiment, description will be given of the case in which a member of a general family access, from a general-purpose computer, a server that provides a eating habit supporting service to make out a menu. In this case, information stored in the server can be stored in a storage medium such as a CD-ROM and then processed on a standalone computer.

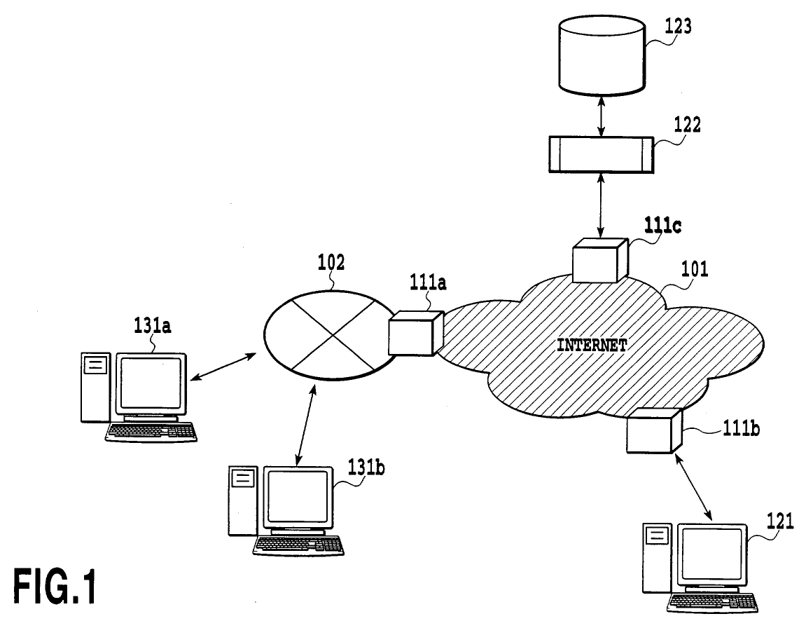

FIG. 1 shows a configuration of a support system of eating habits according to an embodiment of the present invention. The support system of eating habits is used over the Internet 101 or an Intranet 102 connected to the Internet 101 via a gateway 111a. A database 123 of a provider of eating habit supporting services and a server 122 that processes and distributes information stored in the database 123 are connected to the Internet 101 via the gateway 111c. Further, a terminal 121 used by a housewife of a general family, who is a user of the support system of eating habits, is connected to the Internet 101 via the gateway 111b.

The server 122 and the database 123 may be connected directly to the Intranet 102 so as to be accessed by terminals 121, 131a, and 131b. Further, the terminals 121, 131a, and 131b have only to be able to be connected to the Internet 101 or the Intranet 102 by wire or radio. These terminals include terminals connected to the network via cellular phones or PHSs (Personal Handyphone Systems), mobile computers, or televisions having a bidirectional communication function.

With this configuration, the terminals 121, 131a, and 131b access the server 122 via the Internet 101 or the Intranet 102. The server 122 retrieves required information from the database 123 in response to a request from the terminal 121, 131a, or 131b to process the information. The server 122 allows the processed information to be viewed by users or distributes it in the form of a text or image file. The server 122 stores an application that executes these functions.

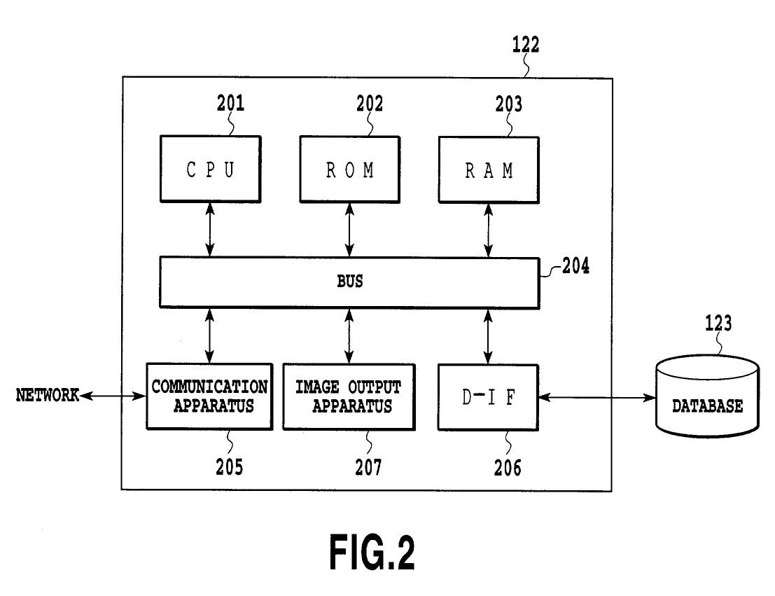

FIG. 2 shows the hardware configuration of the server in the support system of eating habits according to the above embodiment of the present invention. The server 122 comprises a CPU 201 acting as a control section that controls the entire server, a ROM 202 in which programs are stored, and a RAM 203 that provides a temporary data storage region required to execute the programs. These components are connected together via a bus 204. The server 122 further comprises a communication apparatus 205 having the function of an input section that allows the server to connect to the Internet 101 or the Intranet 102, a digital interface 206 that communicates information to and from the database 123, corresponding to a storage section, and an image output apparatus 207 that generates display screens transmitted to clients' terminals. These components are connected to the CPU 201 via the bus 204.

With this configuration, a connection request from the terminal 121, 131a, or 131b is transmitted to the CPU 201 via the Internet 101 or the Intranet 102, the communication apparatus 204, and the bus 204. In response to this request, the CPU 201 transmits a login screen to the terminal 121, 131a, or 131b through the image output apparatus 207. The user inputs required information to the login screen and then transmits it to the CPU 201 as in the case with the connection request. The login screen can be created using a hyper text document in an HTML (Hyper Text Markup Language) format and can be based on operations of buttons specified by tags and storage areas for input information. The server 122 thus provides the user with information or prompts him or her to input information using the display screen transmitted from the image output apparatus 207 to the terminal 121, 131a, or 131b. These functions are accomplished by the CPU 201 executing the programs stored in the ROM 202.

### First Embodiment

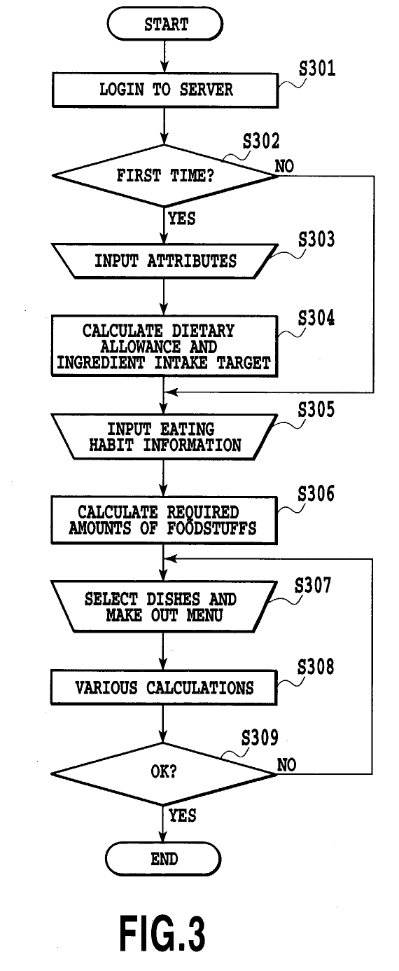

FIG. 3 is a flow chart showing a method for supporting eating habits according to a first embodiment of the present invention. In response to a connection request from the terminal 121, 131a, or 131b, the server 122 displays a login screen (S301). When the user, a housewife engaged in cooking, inputs required information to complete login, the server 122 displays an initial screen to inquire whether or not the user uses this system for the first time (S302).

If the housewife uses this system for the first time, she inputs, from the terminal 121, 131a, or 131b, the attributes of all family members sitting around a dining table (S303). The server 122 stores the input attributes in a user data section 302 of the database 123. The attributes are information including the sexes, ages, heights, weights, intensity of daily activities of the family members, whether or not the housewife is pregnant or nurses a baby, and whether or not any family member is on a restricted diet. For a member on a restricted diet, the housewife inputs the upper and lower limit values for the dietary requirement (corresponds to RDI: the Reference Daily Intakes and/or DRV: the Daily Reference Values) of each nutrient. Further, the housewife can input nutrients to be positively taken in or to be avoided if possible, in the form of upper or lower limit values, respectively. The server 122 determines a dietary requirement for one day per family member on the basis of his or her sex, age, height, and weight. The server 122 then calculates a dietary requirement for a predetermined period, e.g. one week. If any of the above upper or lower limit values has been input, the calculations are executed considering this value.

Furthermore, the server determines an ingredient intake target per family member for each food group for one day to calculate a whole week's ingredient intake target (S304). The housewife may input food groups to be positively eaten or to be avoided if possible, in the form of upper or lower limit values, respectively. Further, if any the above upper or lower limit values for dietary requirements has been input, the server may give the top priority to this nutrient in determining the ingredient intake target for each food group.

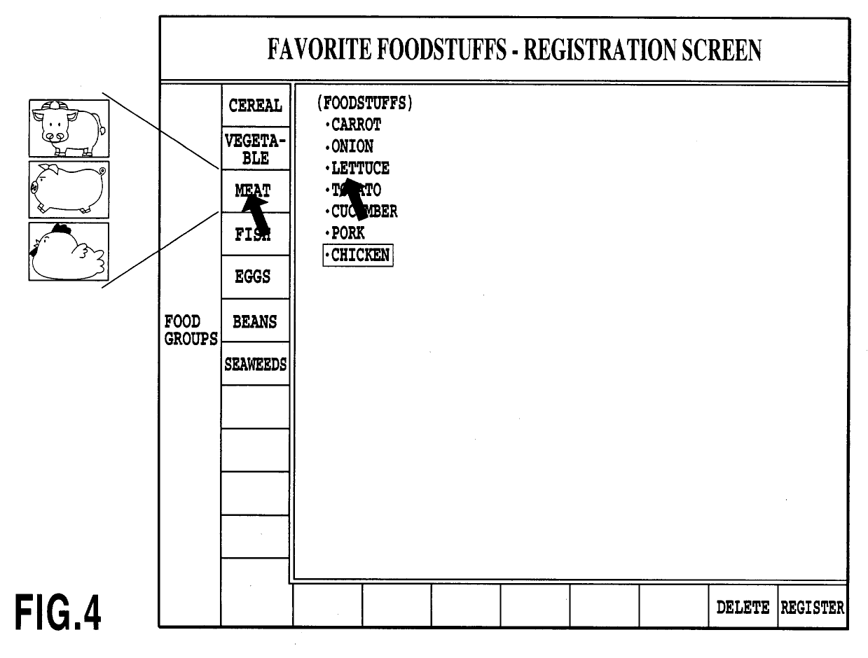

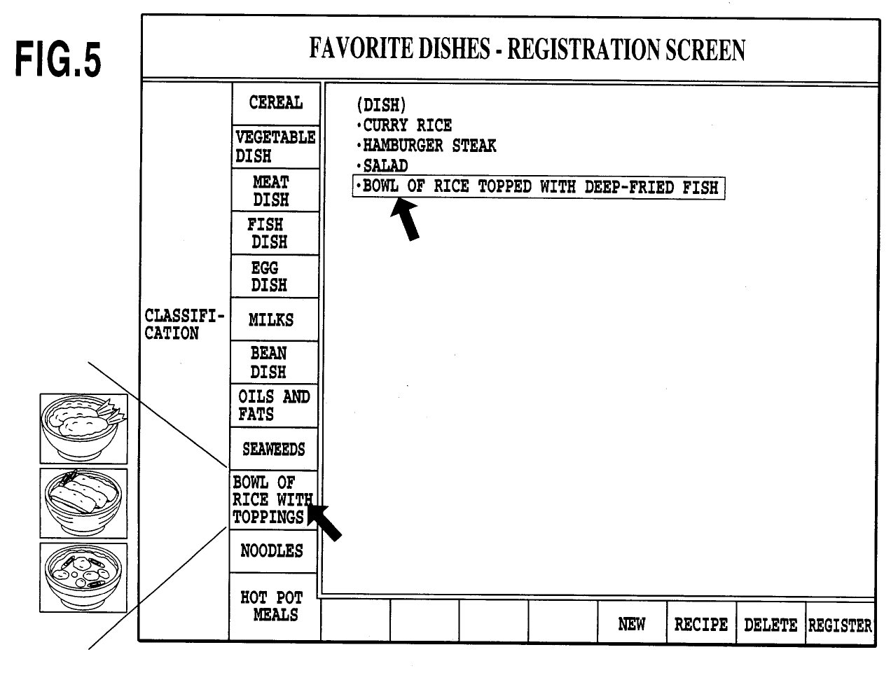

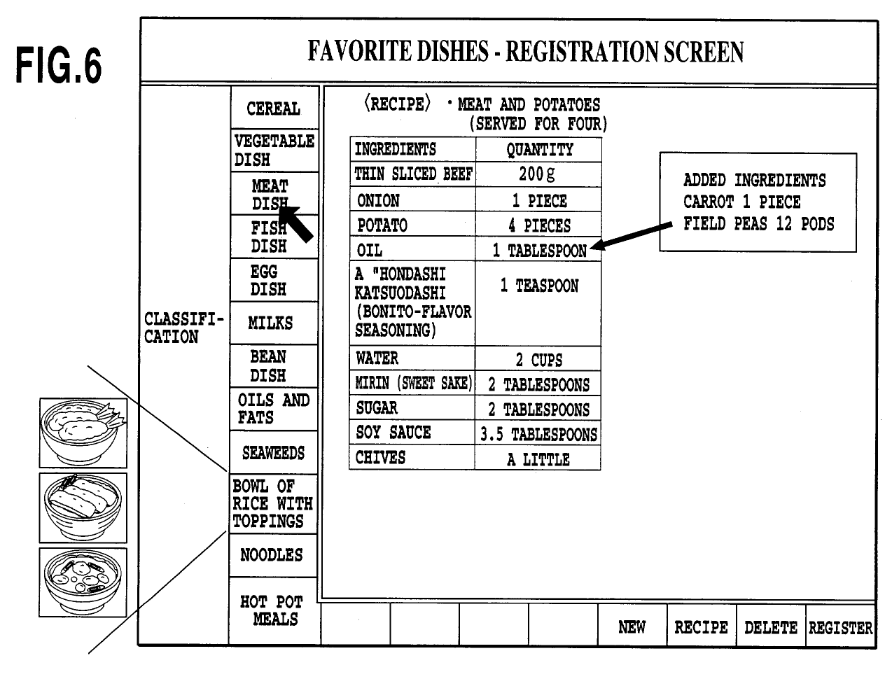

Then, the housewife inputs eating habits information characteristic of the family (S305). FIG. 4 shows a screen in which foodstuffs often used for the family are registered. FIG. 5 shows a screen in which dishes often prepared for the family are registered. Foodstuffs often used by general families or dishes often prepared for them are limited because of differences in tastes of the family members and the habit of buying a whole week's supply of dishes at a time. Accordingly, these can be registered in advance. Foodstuffs have already been registered in the database 123 so as to be classified into corresponding food groups. Thus, any of these foodstuffs can be selected. Dishes can be selected from dish data already registered in the database 123 or this data can be customized. FIG. 6 shows a screen in which recipes for dishes often prepared for the family are registered. The customization is carried out by changing foodstuffs used in the already registered dish data or adding foodstuffs used to the data. Further, new dishes not registered in the database 123 may be registered.

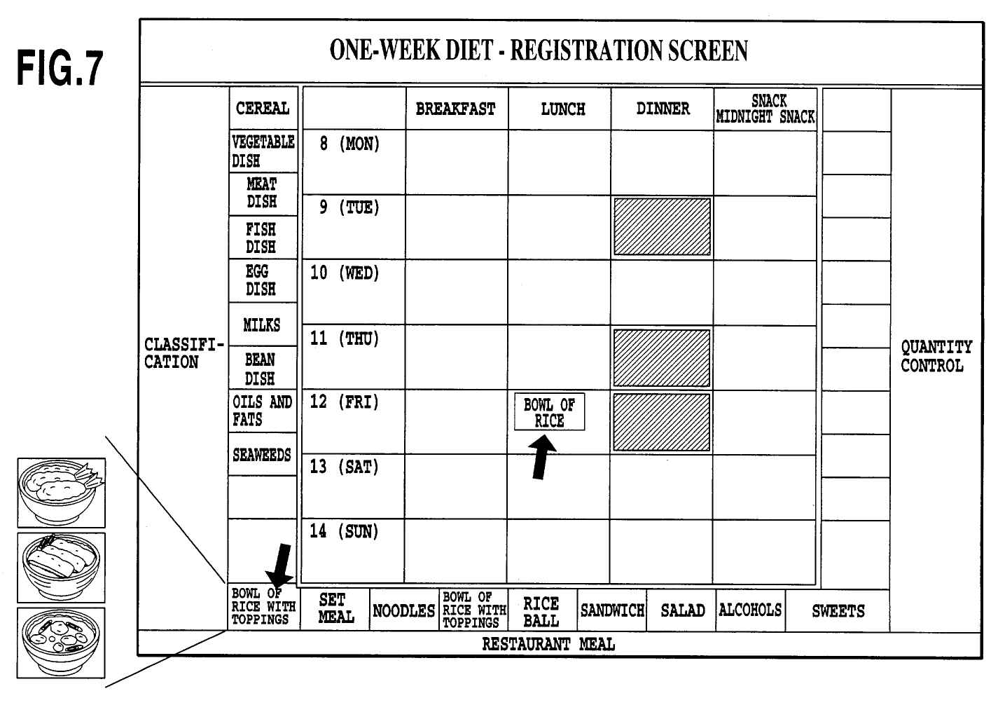

FIG. 7 shows a screen in which a whole week's eating habit information is registered. All members of a general family do not always have three meals together, so that information on a weekly dine-out habit can be registered for each family member. Dined-out dishes can be selected from the dish data already registered in the database 23 or the data can be customized.

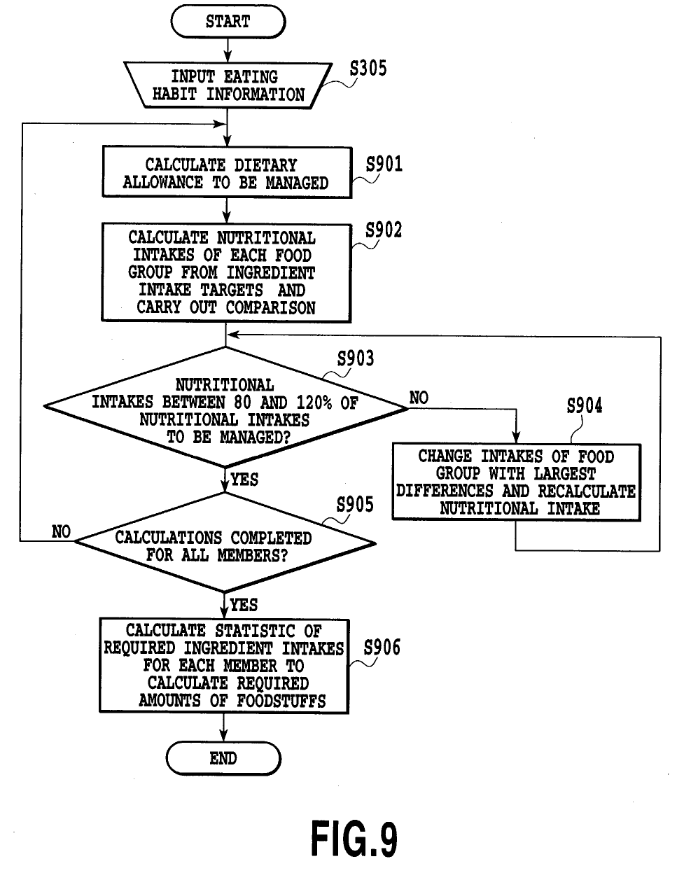

The server 122 stores the input eating habit information in the user data section 302 of the database 123 and calculates nutritive values for the dined-out dishes. The server 122 sets a dietary requirement to be managed by subtracting, from the whole week's dietary requirement calculated at step S304, the sum of the nutritional intake of the restricted diet contained in the attributes input at the step S303 and the nutritional intake of the dined-out dishes. Furthermore, the server calculates a whole week's required ingredient intake target from the dietary requirement to be managed for each family member and calculates a total value for the family members to determine required foodstuffs (S306). A method of determining foodstuffs will be described later in detail with reference to FIG. 9.

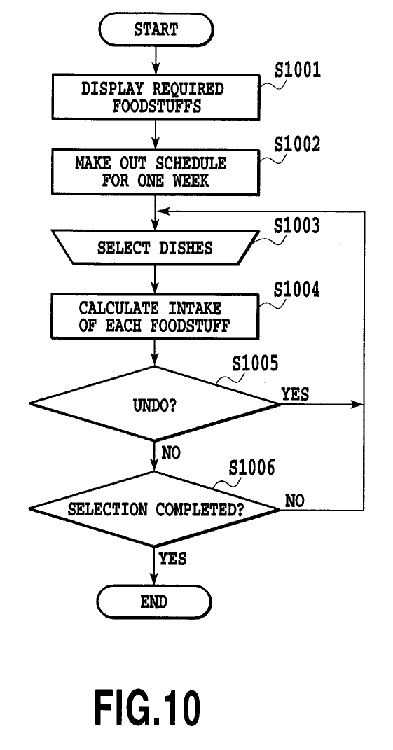

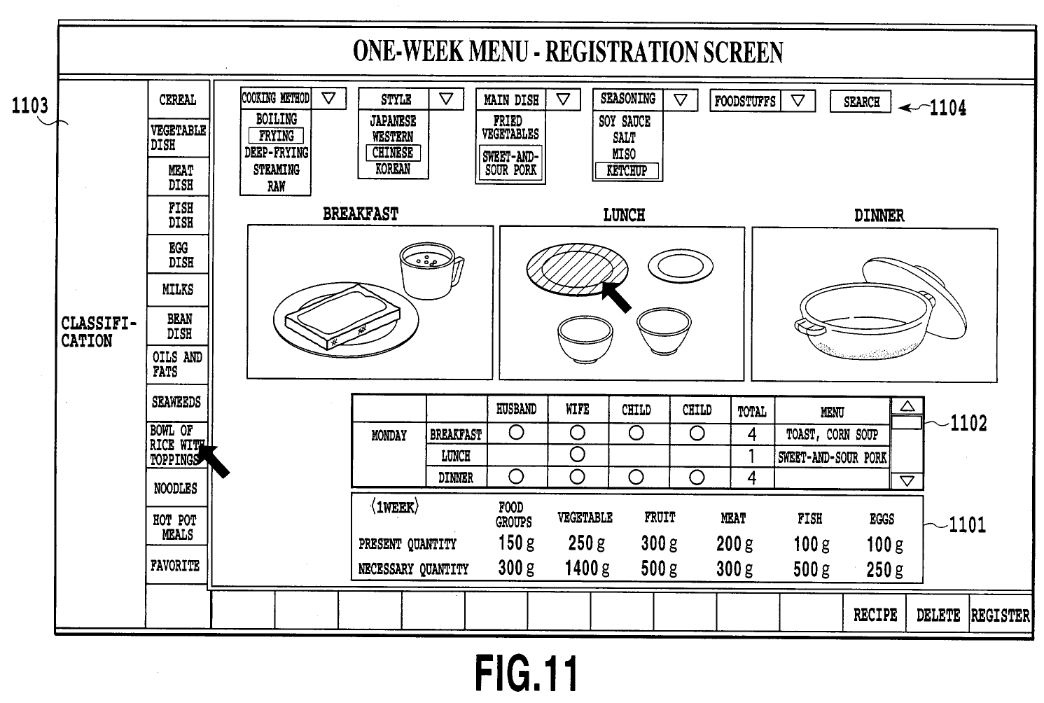

With reference to the determined required foodstuffs, the user selects dishes from the terminal 121, 131a, or 131b to make out a whole week's menu (S307). The server 122 calculates various amounts such as nutritional intakes on the basis of the selected dishes (S308). The user can make out a menu while checking these amounts (S309). A method of making out a menu will be described later in detail with reference to FIGS. 10 and 11.

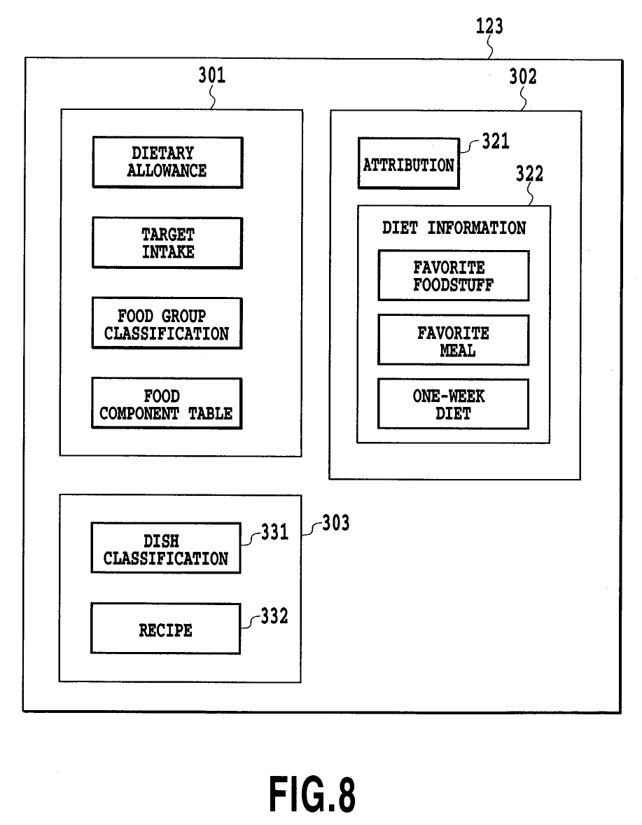

FIG. 8 shows a configuration of the database in the support system of eating habits according to the above embodiment of the present invention. The database 123 contains basic data on which the calculation of the various amounts is based, the user data section 302 that stores data characteristic of the user, and a dish data section 303 that stores data on a classification of dishes, their ingredients, and how to prepare the dishes.

The basic data 301 contains, for example, “Sixth Revised Edition, Japanese Dietary requirement” (edited by Health and Nutrition Information Institute). At step S304, shown in FIG. 3, the server 122 determines a dietary requirement for one day per family member with reference to the basic data 301 on the basis of the input attributes of user, and then stores the dietary requirement for one day in the user data 302. To determine the dietary requirement for one day in further detail, “Revised, Tables of Japanese Food Amino Acid Compositions” (follow-up I of the fourth revised edition of composition tables; edited by Resource Research Institute of Science and Technology Agency) and “Tables of Japanese Food Compositions (follow-up I of the fourth revised edition of composition tables; edited by Resource Research Institute of Science and Technology Agency) can be stored for amino acids and for fatty acids, cholesterol, and vitamin E, respectively, so that the respective dietary requirements can be determined.

The basic data 301 contains, for example, “Intake Target for Each Food Group Corresponding to Dietary requirement” (Health and Nutrition Information Research Institute). At step S304, shown in FIG. 3, the server 122 determines an ingredient intake target for each food group for one day per family member with reference to the basic data 301 on the basis of the input user's attributes, and then stores the ingredient intake target in the user data 302. Alternatively, the basic data 301 contains, for example, “Fifth Revised Edition, Food Component Tables” (edited by Health and Nutrition Information Research Institute).

The user data section 302 stores the attributes 321 input at step S303, shown in FIG. 3, and the eating habit information 322 input at step S305, shown in FIG. 3. Further, the dish data 303 contains a dish classification section 331 that stores keywords and the like for retrieval and a recipe section 332 that stores data on foodstuffs of each dish and how to prepare the dish. At step S305, shown in FIG. 3, the dined-out dish is selected from the often prepared dishes contained in the dish data 303 or the eating habit information 322. At step S306, shown in FIG. 3, the server 122 calculates the nutritional intake of the selected dish with reference to the “Fifth Revised Edition, Food Component Table” in the basic table 301.

FIG. 9 is a flow chart showing a method of calculating required foodstuffs according to the method for supporting eating habits. When eating habit information characteristic of the users is input (S305), the server calculates the nutritional intakes of the dined-out dishes. Then, the server sets a dietary requirement to be managed by subtracting the corresponding nutritional intake of the dined-out dishes from the whole week's dietary requirement calculated at step S304 (S901). With reference to the basis data 301 in the database 301, e.g. “Fifth Revised Edition, Food Component Tables”, the server 122 calculates the nutritional intake of each food group from the a whole week's ingredient intake target calculated at step S304 to compare it with the dietary requirement to be managed (S902).

The server determines the required amounts of foodstuffs so that a difference between the calculated dietary requirement and the dietary requirement to be managed falls within a predetermined range. At this time, the server references the user data 302 in the database 123 to preferentially increase or reduce the amounts of foodstuffs often used which have been registered in the registration screen shown in FIG. 4. If the result of the comparison indicates that the difference between the calculated dietary requirement and the dietary requirement to be managed falls within a predetermined range, e.g. the former amounts to 80 to 120% of the latter (S903), then the intake of the food group with the largest difference is increased or reduced. Then, the nutritional intake is further recalculated (S904). To limit the difference between the calculated dietary requirement and the dietary requirement to be managed, to within the predetermined range, the upper or lower limit values input at step S303 may be preferentially increased or reduced. Alternatively, if any food group to be positively eaten or to be avoided if possible has been input, the intake of this food group may be preferentially increased or reduced.

If the difference falls within the predetermined range for all food groups, then a required ingredient intake is similarly calculated for all family members (S905). The server 122 calculates the total value for all family members to determine the required amounts of foodstuffs for each food group (S906).

FIG. 10 is a flow chart showing a method for making out a menu according to the method of supporting eating habits. Further, FIG. 11 shows a screen used to make out a menu according to the method for supporting eating habits. A foodstuff column 1101 shows the sum of required amounts of foodstuffs which have been determined at step S306, shown in FIG. 3, and the amounts of foodstuffs resulting from the process of making out the menu (S1001). On the basis of the weekly eating habit information input at step S305, shown in FIG. 3, a schedule 1102 shows family members who have three meals together on each day of the week (S1002).

Then, the user selects dishes served for breakfast, lunch, and supper for each day of the week (S1003). First, pieces of tableware required for dishes associated with rice, bread, or noodle as a staple food are selected assuming a dining table on which these pieces of tableware are arranged. Cooking utensils are selected for one-pot dishes cooked at the table or meats and vegetables grilled on an iron plate. The numbers of bowls and plates can be arbitrarily selected. Then, foods are selected which are dished up into these bowls or plates.

The dishes may be selected on the basis of a classification of dishes 1103 or by retrievals using keywords 1104 for seasoning or foodstuffs. Since retrieved items are divided into groups along a process in which the cook makes out a menu, selections from the menu data 303 is easy. For example, a pulldown menu displays keywords for each item so that the user can select any keyword.

FIG. 11 shows that the user has already selected all dishes for breakfast and is selecting “sweet-and-sour pork” as a main dish for lunch. As in the case with the screen in which dishes often prepared for the family are registered as shown in FIG. 5, this item may be selected from the dish data 303 in the database 123 on the basis of the classification of dishes 1103 or from the user data 302 as one of the dishes often prepared for the family which have been registered in the screen shown in FIGS. 5 and 6.

Every time dishes are selected, the server 122 calculates the amounts of foodstuffs used on the basis of the recipes 332 in the dish data 303 (S1004). The server then changes the current amounts of foodstuffs in the foodstuff column 1101. With reference to the foodstuff column 1101, the user makes out a whole week's menu so that the family members can eat the required foodstuffs (S1005, S1006).

It is ideal that, as a result of a process of making out a whole week's menu, the current values for the foodstuffs in the foodstuff column 1101 equal the values for the required foodstuffs. However, it is difficult to achieve this for all food groups. Thus, as in the case with the screen in which recipes for dishes often prepared for the family are registered, the selected recipes for the selected dishes can be altered. That is, if the amounts of vegetables are not enough as a result of a process of making out a menu, these amounts can be made equal to the required amounts easily by adding these vegetables to the already selected dish instead of adding another vegetable dish.

In this manner, dishes can be selected not only from the existing ones but also ones often prepared for the family, or the recipes for the selected dishes can be altered. Accordingly, foodstuffs can be arbitrarily combined together. Required nutritional management can be achieved while selecting foodstuffs according to the likes and dislikes of the family members or selecting foodstuffs from those always reserved at home.

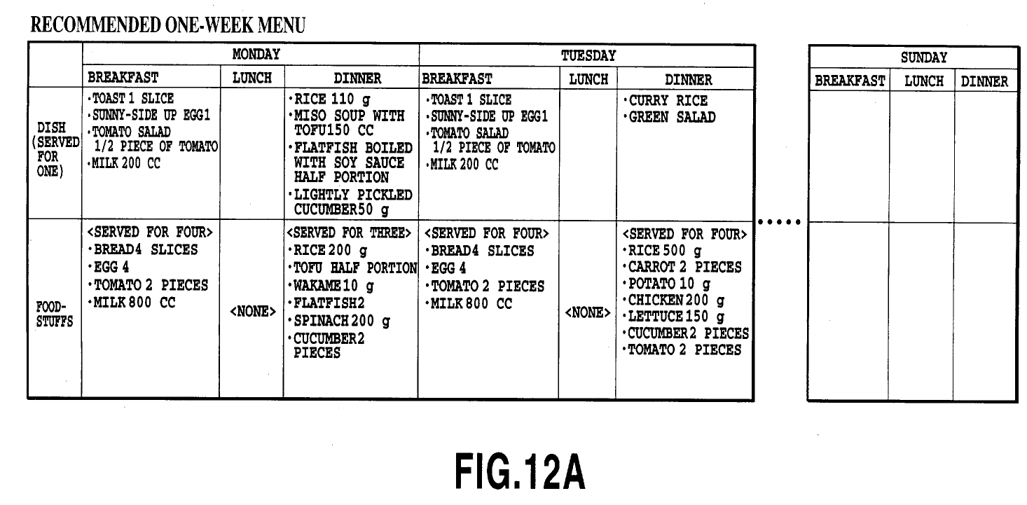

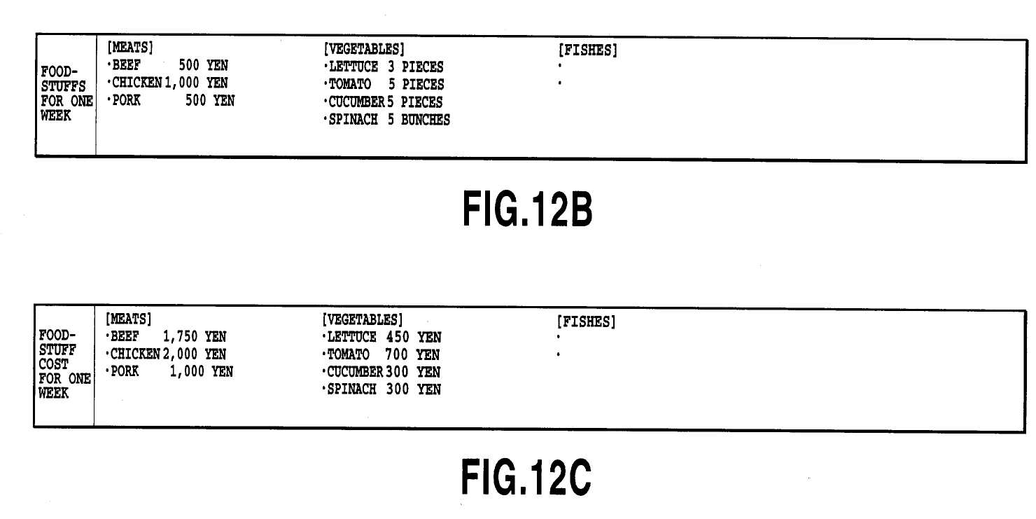

FIGS. 12A to 12C show an example of the results of output of a menu made out according to the method for supporting eating habits. FIG. 12A is a table showing the contents of three meals on each day of the week. This figure shows selected dishes and foodstuffs used which have been selected from the recipes 332 in the dish data 303. FIG. 12B shows the totals of a whole week's amounts of foodstuffs. In the present embodiment, it is assumed that the foodstuffs are used for four family members for one week. Thus, on the basis of this assumption, the user can buy foodstuffs without wasting money. Further, by storing the purchase price of each foodstuff as the basic data 301 in the database 123, the purchase prices of a whole week's amounts of foodstuffs can be displayed as shown in FIG. 12C. Furthermore, by storing a made-out menu in the database 123 and writing its effects to the database later, the eating habits of family members can be diagnosed.

### Second Embodiment

In the description of the first embodiment, a menu is made out considering the balance of all nutrients and ingredients. In the description of a second embodiment, vegetables, the intake of which is likely to be insufficient in the daily life, are focused on, and a menu is made out which contains a large amount of vegetables. A menu containing a large amount of vegetables allows the user to easily take in required nutrients. By properly utilizing vegetables in season, a nice and inexpensive menu can be made out.

The basic flow of a method for supporting eating habits according to the second embodiment is the same as that in the flow chart shown in FIG. 3. A specific example not shown in the first embodiment will be described with reference to the corresponding drawings.

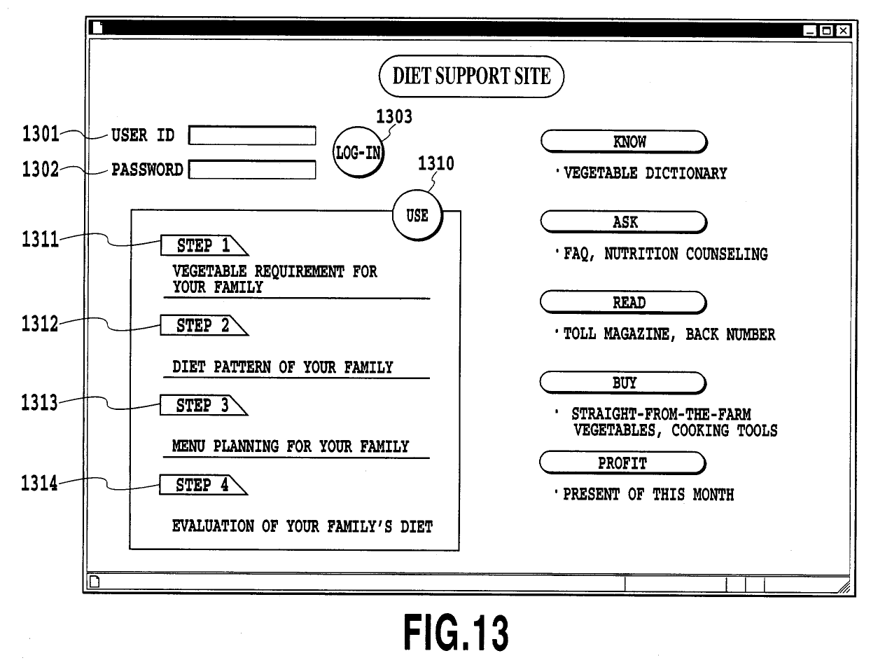

FIG. 13 shows a login screen. This is a screen displayed at step S301 in FIG. 3. In the login screen 1300, the housewife, the user, inputs performs a login operation by inputting her user ID 1301 and password 1302 and selecting a login button 1303. The method of supporting eating habits according to the second embodiment can be started from its beginning by selecting a “use” button 1310 or from a certain step in the middle of the method by selecting a corresponding “step” button 1311, 1312, 1313, or 1314.

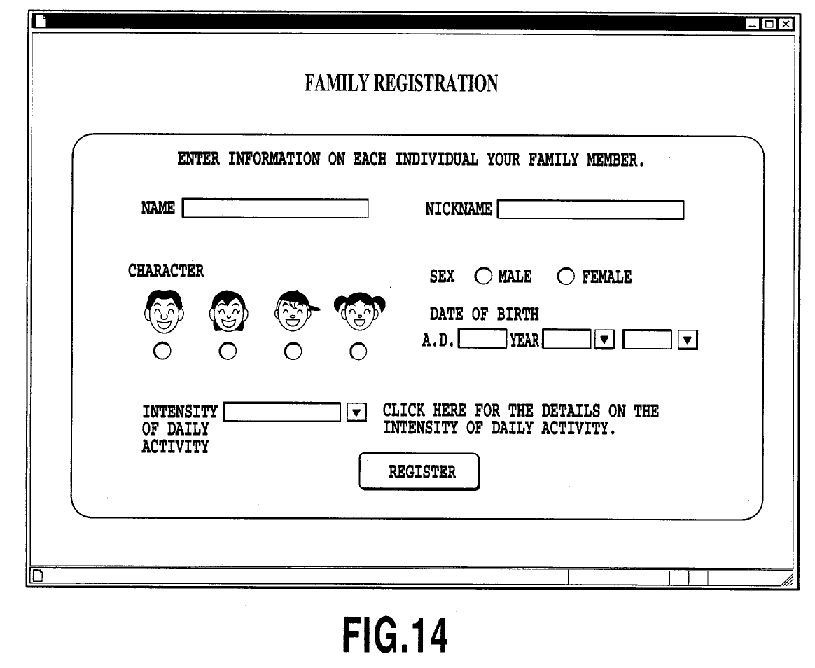

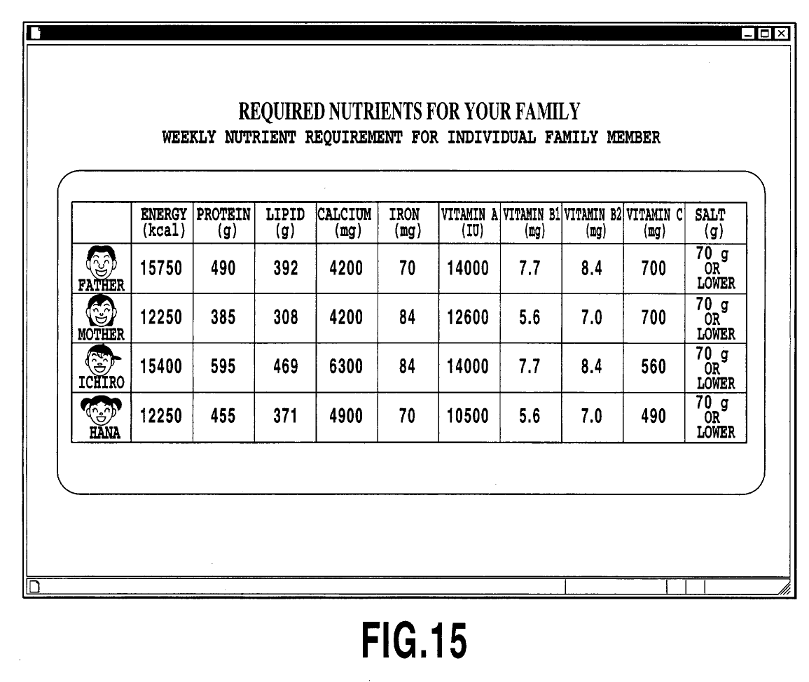

FIG. 14 shows an attribute input screen. This is a screen displayed at step S303 in FIG. 3. In this screen, the user inputs her sex, birth date, and intensity of daily activities. Selecting a register button allows input attributes to be stored in the user data section 302 of the database 123, shown in FIG. 8. FIG. 15 shows the results of calculation of a whole week's dietary requirements. These are the results of calculation of a whole week's dietary requirements per family member carried out with reference to the basic data 301 in the database 123.

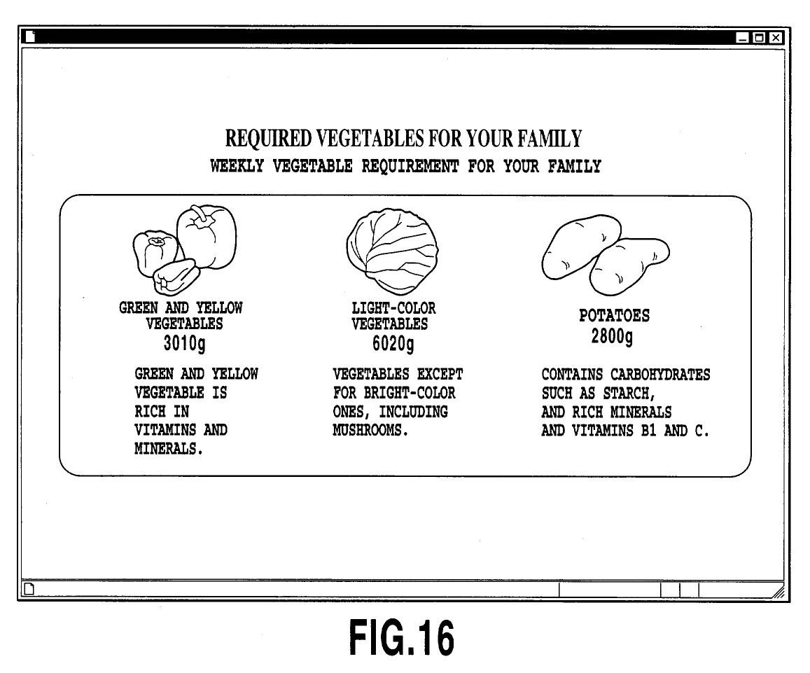

Then, at step S304 in FIG. 3, on the basis of the input user's attributes, an ingredient intake target for each food group for one day per family member is determined to calculate a whole week's ingredient intake target. At this time, information is provided which is required to make out a menu containing a large amount of vegetables. FIG. 16 shows a screen that displays the required intakes of vegetables. With reference to the basic data 301, the server 122 divides the vegetables into three types including green and yellow ones, light-colored ones, and potatoes. The server 122 then calculates and displays a whole week's ingredient intake target is calculated for all family members.

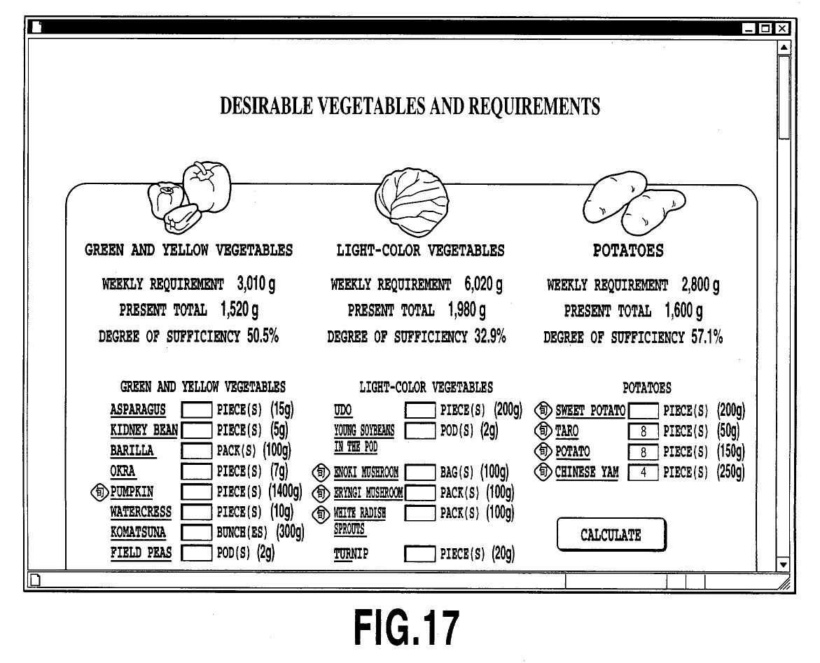

FIG. 17 shows a screen in which desired vegetables are input. The intake of each of the three types of vegetables is input so as to meet the intake calculated in FIG. 16, considering foodstuffs often used for the family and the favorite vegetables of family members. This enables an ingredient intake target for each food group to be determined by giving the top priority to a food group to be positively eaten, i.e. vegetables.

Then, as in the case with the first embodiment, at step S305 in FIG. 3, eating habit information is input. At step S306, the server 122 determines required foodstuffs. The details of a method for determining foodstuffs are the same as those in the flow chart in FIG. 9.

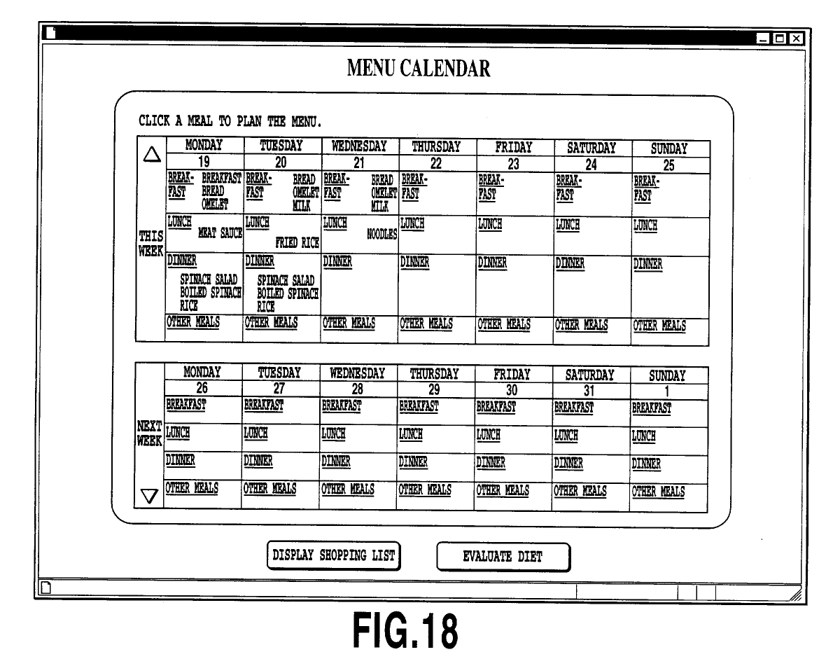

With reference to the flow chart in FIG. 10, description will be given of a process of making out a whole week's menu at step S307 in FIG. 3. FIG. 18 shows a menu calendar screen used to make out a menu. The user selects dishes served for breakfast, lunch, and supper (S1003). In FIG. 18, supper for the 21st, Tuesday is input (S1003). In the second embodiment, since a menu containing a large amount of vegetables is to be made out, a screen used to select theme vegetables is first displayed when “supper” is selected from the menu calendar.

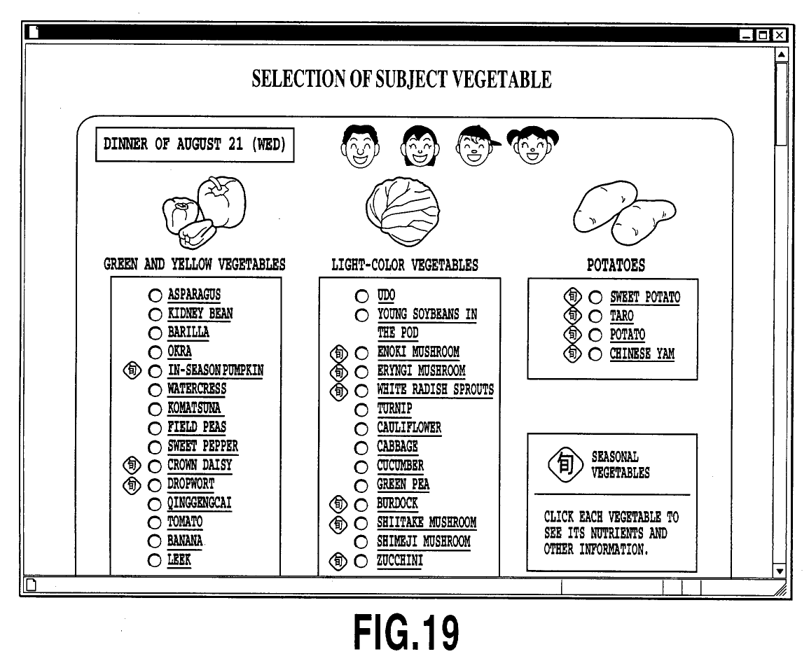

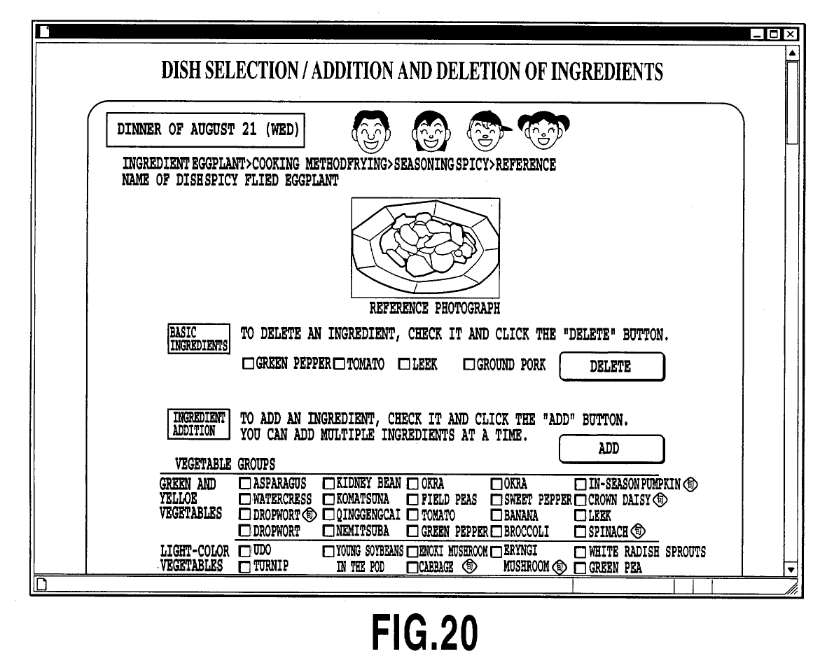

FIG. 19 shows a screen used to select theme vegetables. As in the case with the screen shown in FIG. 17, theme vegetables for the supper for the 21st, Tuesday can be selected for each of the three types of vegetables. On the basis of the selected theme vegetables, the server 122 retrieves the dish data 303 from the database 123, shown in FIG. 8, to display it on, for example, another window. When the user selects any of the displayed dishes, the screen shown in FIG. 20 is displayed.

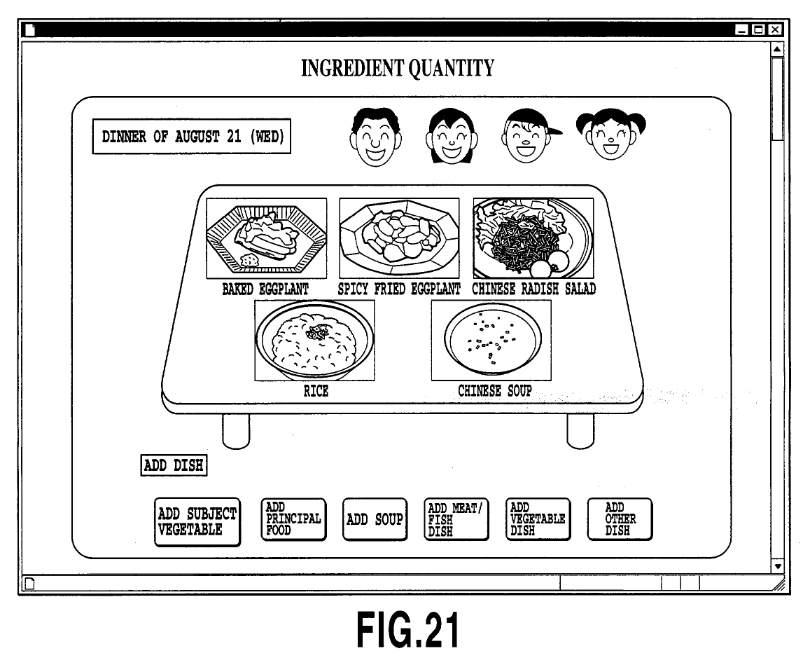

FIG. 20 is a screen used to determine dishes. The server 122 displays foodstuffs used for the recipes 232 in the dish data 303. In this screen, the user can delete some of the basic ingredients or add foodstuffs not contained in the recipes. In this manner, dishes to be prepared for the supper are selected one by one. FIG. 21 shows a screen displayed when all dishes have been selected. This method enables a menu for the day to be made out assuming family members sitting at a dining table and dishes arranged on the table.

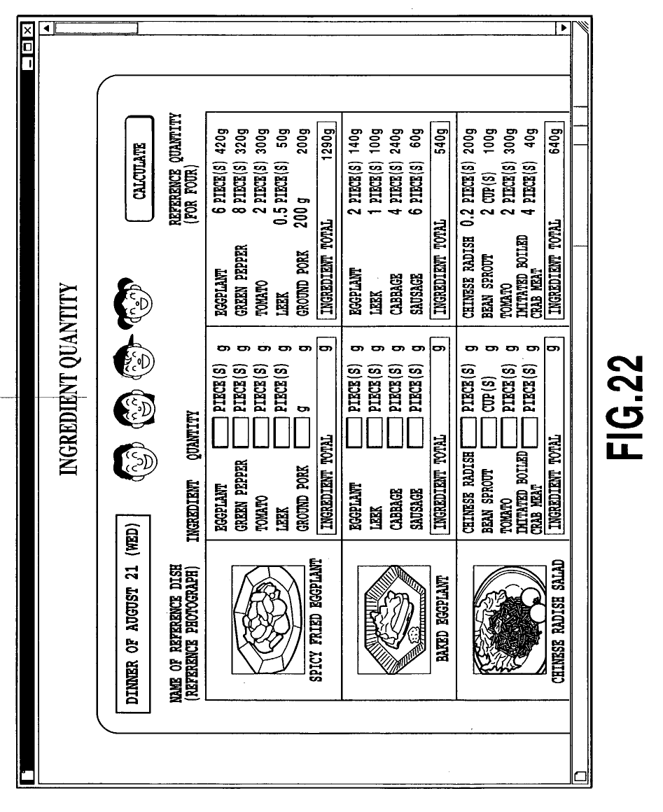

FIG. 22 shows a screen used to change the amounts of ingredients of dishes. It is ideal that the family members can eat all required foodstuffs as a result of a process of making out a whole week's menu. However, it is difficult to meet the required intake for all food groups. Accordingly, it is possible to change the amounts of ingredients depending on the foodstuffs reserved at home on that day. Thus, ingredients used for the dishes cannot only be deleted or added but their amounts can also be changed, thus allowing the required intake to be met easily.

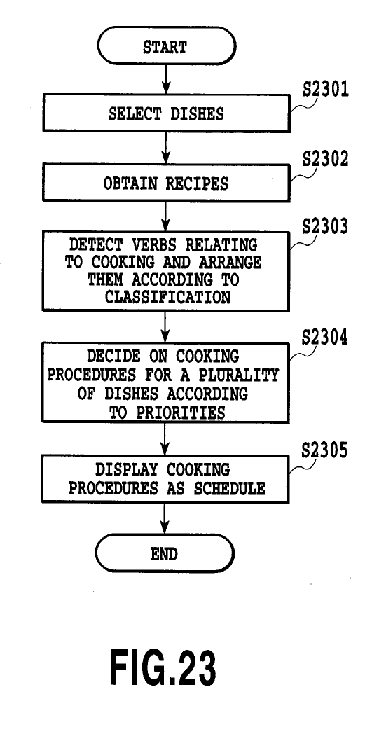

FIG. 23 is a flow chart showing a method of creating a manner of preparing dishes. On the basis of the menu calendar screen shown in FIG. 18 and the results of selection of dishes shown in FIG. 21, a manner of preparing dishes arranged on the table can be displayed. Once dishes are selected (S2301), the server 122 retrieves the dish data 303 from the database 123, shown in FIG. 8, to obtain the recipes 332 for all dishes arranged on the table (S2302).

The server 122 retrieves verbs relating to the cooking in the recipes 332 for the individual dishes and arranges the verbs according to a classification (S2303). The classification involves four categories including preprocessing of ingredients, preparations, cooking, and finish. Sauted dishes and deep-fried dishes are better while hot. After cooking, soup may be heated again before being placed on the table. On the basis of this, priorities are given to the verbs relating to the cooking to determine a procedure of cooking a plurality of dishes (S2304).

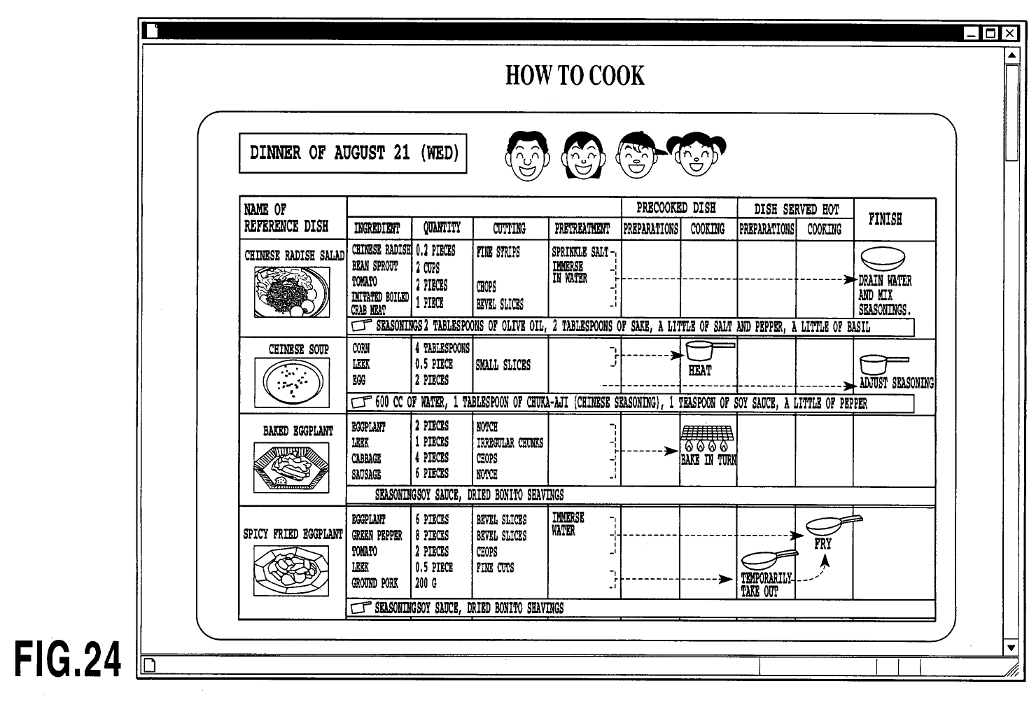

For example, as shown in FIG. 24, the dishes are divided into a group to be cooked earlier and a group that is better while hot. Then, cooking procedures are decided on, and a schedule is made out and displayed (S2305). Thus, a menu cannot only be made out but cooking procedures for dishes to be arranged on the table on that day can also be displayed. Consequently, dishes can be served efficiently and quickly.

As described above, nutrition for a plurality of members can be managed for a predetermined period using familiar foodstuffs and often served dishes. Further, on the basis of a thus made-out menu, the support system of eating habits can provided various incidental services.

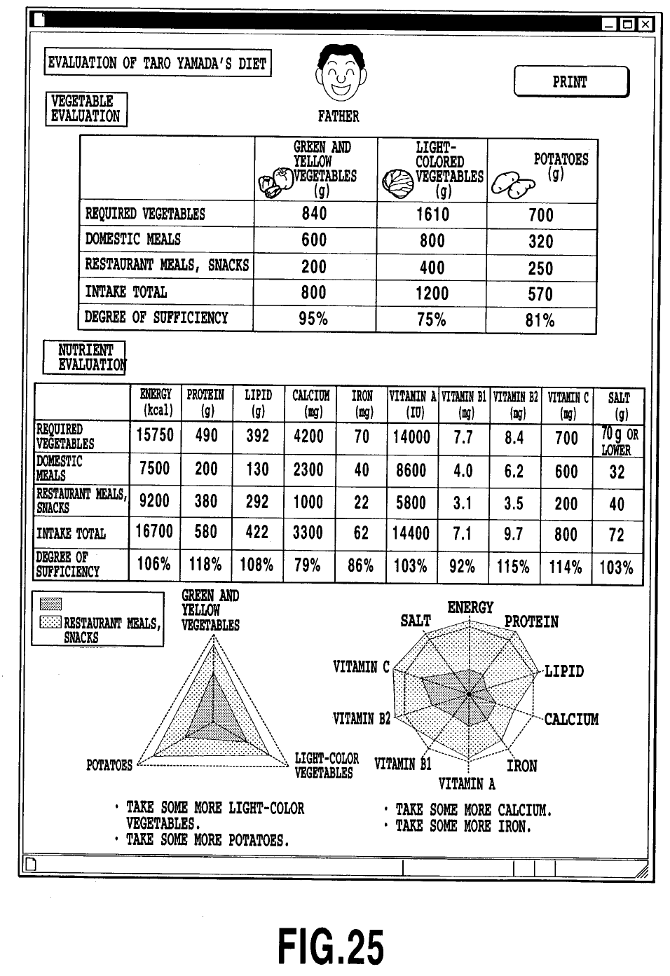

FIG. 25 shows a screen that displays the results of an eating habit diagnosis. In the screen shown in FIG. 7, a whole week's eating habit information and the menu shown in FIGS. 12A to 12C or 18 are registered. Accordingly, a whole week's accurate nutritional intake including the intake of dined-out dishes can be calculated. For example, as shown in FIG. 25, if a menu containing a large amount of vegetables is made out, the results of an eating habit diagnosis are displayed by showing the level of sufficiency of vegetables and making a graph of the level of sufficiency of each nutrient.

For example, as shown in the login screen 1300 in FIG. 13, prompt and careful nutritional consultations can be given by providing a button used to access a server for nutritional consultations and transmitting menus stored in the database 123, shown in FIG. 8, to the server.

The output results of the menu shown in FIGS. 12A to 12C show the totals of intakes of nutrients from a whole week's amounts of foodstuffs. Thus, by dividing each total intake by the weight of an average ingredient, the amount of ingredient to be purchased can be determined to make out a purchase list. For example, as shown in the login screen in FIG. 13, ingredients can be bought through e-commerce on the basis of calculated purchase amounts by providing a button used to access a server that accepts orders for vegetables fresh from growing areas.

Furthermore, as shown in the login screen 1300 in FIG. 13, by allowing the user to obtain information on foodstuffs, advertisements for foodstuffs and cooking utensils, or information on sales promotion, a support system of eating habits can be provided which can support not only support a process of making out a menu but also general matters on eating habits.

The present invention has been described in detail with respect to preferred embodiments, and it will now be apparent from the foregoing to those skilled in the art that changes and modifications may be made without departing from the invention in its broader aspects, and it is the intention, therefore, in the appended claims to cover all such changes and modifications as fall within the true spirit of the invention.

What is claimed is:

1. A method for supporting eating habits in which, when a menu for a predetermined period is made out for one or more members sitting around a table, a control section makes out the menu with reference to a storage section on the basis of eating habit information obtained from an input section, the storage section having a table that stores dietary requirements for one day and ingredient intake targets for respective foodstuffs classified into food groups, the dietary requirements and ingredient intake targets being based on attributes of the members, as well as food nutritive components of each foodstuff or dish, the method comprising:
a first calculating step of determining, for each of said members, a dietary requirement for said predetermined period and an ingredient intake target for said predetermined period, with reference to said table on the basis of the attributes of each member stored in said storage section;
a first inputting step of obtaining eating habit information on foodstuffs often used from said input section to store the information in said storage section;
a second calculating step of subtracting the nutritional intake of a restricted diet contained in said attributes from the dietary requirement for said predetermined period which has been determined at said first calculating step, to determine a nutritional intake to be managed;
a third calculating step of determining, from the ingredient intake target for said predetermined period which has been determined at said first calculating step, a difference between the nutritional intake calculated with reference to said table and said nutritional intake to be managed which has been determined at said second calculating step; and
a fourth calculating step of minimizing said difference determined at said third calculating step on the basis of said eating habit information on foodstuffs often used which has been obtained at said first inputting step, to determine a required ingredient intake for the predetermined period.

2. A method for supporting eating habits according to claim 1, wherein said first inputting step comprises obtaining eating habit information on dine-out for each of said members from said input section to store the information in said storage section, and
wherein said third calculating step comprises subtracting, from the dietary requirement for said predetermined period, a nutritional intake calculated from said eating habit information on dine-out obtained at said first inputting step.

3. A method for supporting eating habits according to claim 1, further comprising:
a second inputting step of obtaining selected dishes to store the dishes in said storage sections in order to make out a menu for the predetermined period; and
a display step of displaying, for said dishes selected at the second inputting step, the amounts of foodstuffs calculated with reference to said table and required ingredient intakes for said predetermined period which have been determined at said fourth calculating step.

4. A method for supporting eating habits according to claim 3, wherein said first inputting step enables eating habit information on often served dishes to be obtained and stored in said storage section, and
wherein said second inputting step enables selection of dishes contained in said eating habit information on often served dishes which has been obtained at said first inputting step and then stored in said storage section.

5. A method for supporting eating habits according to claim 3 or 4, wherein said second input step enables foodstuffs used for said selected dishes to be added or deleted and then enables resulting foodstuffs to be stored in said storage section.

6. A method for supporting eating habits according to claim 3 or 4, wherein said second inputting step enables the amounts of foodstuffs used for said selected dishes to be changed and then enables the resulting amounts to be stored in said storage section.

7. A method for supporting eating habits according to claim 3 or 4, wherein said second inputting step comprises carrying out retrievals using at least one keyword for cookery, classification, basic menus, seasoning, and foodstuffs.

8. A method for supporting eating habits according to claim 3 or 4, wherein said display step comprises calculating and displaying the sum of amount of each foodstuff required for the predetermined period.

9. A method for supporting eating habits according to claim 8, wherein said display step comprises calculating the amount of each foodstuff to be purchased from said sum of amount of foodstuff required for the predetermined period and displaying a purchase price of amount of foodstuff required for the predetermined period.

10. A method for supporting eating habits according to claim 3 or 4, wherein said storage section has a recipe table in which a manner of preparing each dish is stored, and
wherein the method comprises a procedure making-out step of, for said plurality of dishes selected at said second inputting step, detecting and classifying verbs relating to cooking for each dish with reference to said recipe table and making out a cooking procedure by rearranging the detected verbs.

11. A method for supporting eating habits according to claim 1 or 2, further comprising a diagnosis step of storing, in said storage section, the nutritional intake calculated from said eating habit information on dine-out and said nutritional intake to be managed and displaying nutritional intakes for the predetermined period in order to diagnose eating habits.

12. A support system of eating habits which supports a user in making out a menu for a predetermined period for one or more members sitting around a table, the system comprising:
storage means having a table that stores dietary requirements for one day and ingredient intake targets for respective foodstuffs classified into food groups, the dietary requirements and ingredient intake targets being based on attributes of the members, as well as food nutritive components of each foodstuff or dish;
first calculating means for determining, for each of said members, a dietary requirement for said predetermined period and an ingredient intake target for said predetermined period, with reference to said table on the basis of the attributes of each member stored in said storage section;
first inputting means for obtaining eating habit information on foodstuffs often used from said input section to store the information in said storage section;
second calculating means for subtracting the nutritional intake of a restricted diet contained in said attributes from the dietary requirement for said predetermined period which has been determined by said first calculating means, to determine a nutritional intake to be managed;
third calculating means for determining, from the ingredient intake target for said predetermined period which has been determined by said first calculating means, a difference between the nutritional intake calculated with reference to said table and said nutritional intake to be managed which has been determined by said second calculating means; and
fourth calculating means for minimizing said difference determined by said third calculating means on the basis of said eating habit information on foodstuffs often used which has been obtained by said first inputting means, to determine a required ingredient intake for the predetermined period.

13. A storage medium in which a program executed by a control section is recorded, the control section operating when a menu for a predetermined period is made out for one or more members sitting around a table, to make out the menu with reference to a storage section on the basis of eating habit information obtained from an input section, the storage section having a table that stores dietary requirements for one day and ingredient intake targets for respective foodstuffs classified into food groups, the dietary requirements and ingredient intake targets being based on attributes the members, as well as food nutritive components of each foodstuff or dish, the program allowing a computer to execute:
a first calculating step of determining, for each of said members, a dietary requirement for said predetermined period and an ingredient intake target for said predetermined period, with reference to said table on the basis of the attributes of each member stored in said storage section;
a first inputting step of obtaining eating habit information on foodstuffs often used from said input section to store the information in said storage section;
a second calculating step of subtracting the nutritional intake of a restricted diet contained in said attributes from the dietary requirement for said predetermined period which has been determined at said first calculating step, to determine a nutritional intake to be managed;
a third calculating step of determining, from the ingredient intake target for said predetermined period which has been determined at said first calculating step, a difference between the nutritional intake calculated with reference to said table and said nutritional intake to be managed which has been determined at said second calculating step; and
a fourth calculating step of minimizing said difference determined at said third calculating step on the basis of said eating habit information on foodstuffs often used which has been obtained at said first inputting step, to determine a required ingredient intake for the predetermined period.

14. A program executed by a control section operating when a menu for a predetermined period is made out for one or more members sitting around a table, to make out the menu with reference to a storage section on the basis of eating habit information obtained from an input section, the storage section having a table that stores dietary requirements for one day and ingredient intake targets for respective foodstuffs classified into food groups, the dietary requirements and ingredient intake targets being based on attributes of the members, as well as food nutritive components of each foodstuff or dish, the program allowing a computer to execute:
a first calculating step of determining, for each of said members, a dietary requirement for said predetermined period and an ingredient intake target for said predetermined period, with reference to said table on the basis of the attributes of each member stored in said storage section;
a first inputting step of obtaining eating habit information on foodstuffs often used from said input section to store the information in said storage section;
a second calculating step of subtracting the nutritional intake of a restricted diet contained in said attributes from the dietary requirement for said predetermined period which has been determined at said first calculating step, to determine a nutritional intake to be managed;
a third calculating step of determining, from the ingredient intake target for said predetermined period which has been determined at said first calculating step, a difference between the nutritional intake calculated with reference to said table and said nutritional intake to be managed which has been determined at said second calculating step; and
a fourth calculating step of minimizing said difference determined at said third calculating step on the basis of said eating habit information on foodstuffs often used which has been obtained at said first inputting step, to determine a required ingredient intake for the predetermined period.
